(19) United States
(12) Patent Application Publication
(10) Pub. No.: US 2025/0291524 A1
(43) Pub. Date: Sep. 18, 2025

(54) INFORMATION PROCESSING APPARATUS, INKJET PRINTING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Takashi Fujita, Tokyo (JP); Tatsuhiro Yamagata, Tokyo (JP); Okinori Tsuchiya, Kanagawa (JP); Hiromitsu Yamaguchi, Kanagawa (JP); Akitoshi Yamada, Kanagawa (JP); Hidetsugu Kagawa, Kanagawa (JP)

(21) Appl. No.: 19/075,890

(22) Filed: Mar. 11, 2025

(30) Foreign Application Priority Data
Mar. 15, 2024 (JP) 2024-041585

(51) Int. Cl. G06F 3/12; B41J 11/00

(52) U.S. Cl. CPC G06F 3/1205; B41J 11/0005; G06F 3/1215; G06F 3/1258; G06F 3/1264

(57) ABSTRACT

An information processing apparatus controlling an inkjet printing apparatus that prints an image on a printing medium and in which a post-processing mechanism that can execute a plurality of types of post-processing processes on the printing medium printed with the image can be installed at a discharge unit that discharges the printing medium, the information processing apparatus comprises a storage unit storing print settings for printing the image that include at least a first print setting, and a second print setting, which is a print setting for one of the post-processing processes and is different from the first print setting; and a control unit that sets the print setting, wherein in a case where the post-processing mechanism is installed, the control unit can set, as a print setting, the second print setting for discharging the printing medium in a state with curling reduced more compared to the first print setting.

### BACKGROUND

### Technical Field

The present disclosure relates to an information processing apparatus, an inkjet printing apparatus, an information processing method, and a non-transitory computer-readable storage medium.

### Description of the Related Art

When using a printing apparatus such as a printer, a post-processing process performed after printing such as stapling may take time. To solve this problem, a mechanism installed with a post-processing process function may be independently disposed and post-processing may be automatically performed to improve productivity (Japanese Patent Laid-Open No. 2022-70446). However, the installation space is increased by making the post-processing process independent. Regarding this, a printing apparatus is proposed for realizing a post-processing process without increasing space by inserting a small post-processing mechanism at a discharge unit that discharges a printing medium.

### SUMMARY

According to one aspect of the present disclosure, there is provided an information processing apparatus that controls an inkjet printing apparatus that prints an image on a printing medium and in which a post-processing mechanism that can execute a plurality of types of post-processing processes on the printing medium printed with the image can be installed at a discharge unit that discharges the printing medium, the information processing apparatus comprising: a storage unit that stores print settings for printing the image that include at least a first print setting, and a second print setting, which is a print setting for one of the post-processing processes and is different from the first print setting; and a control unit that sets the print setting, wherein in a case where the post-processing mechanism is installed, the control unit can set, as a print setting, the second print setting for discharging the printing medium in a state with curling reduced more compared to the first print setting.

According to another aspect of the present disclosure, there is provided an inkjet printing apparatus, comprising: the above-mentioned information processing apparatus; and a discharge unit that discharges the printing medium with the image printed and is installed with a post-processing mechanism that performs a post-processing process on the printing medium.

According to another aspect of the present disclosure, there is provided an information processing method for controlling an inkjet printing apparatus that prints an image on a printing medium and in which a post-processing mechanism that can execute a plurality of types of post-processing processes on the printing medium printed with the image can be installed at a discharge unit that discharges the printing medium, the method comprising: storing print settings for printing the image that include at least a first print setting, and a second print setting, which is a print setting for one of the post-processing processes and is different from the first print setting; and setting the print setting, wherein in setting the print setting, in a case where the post-processing mechanism is installed, as a print setting, the second print setting for discharging the printing medium in a state with curling reduced more compared to the first print setting can be set.

According to another aspect of the present disclosure, there is provided a non-transitory computer-readable storage medium storing a computer program for causing, when loaded and executed by a computer that controls an inkjet printing apparatus that prints an image on a printing medium and in which a post-processing mechanism that can execute a plurality of types of post-processing processes on the printing medium printed with the image can be installed at a discharge unit that discharges the printing medium, the computer to: store print settings for printing the image that include at least a first print setting, and a second print setting, which is a print setting for one of the post-processing processes and is different from the first print setting; and set the print setting, wherein in setting the print setting, in a case where the post-processing mechanism is installed, as a print setting, the second print setting for discharging the printing medium in a state with curling reduced more compared to the first print setting can be set.

Further features of the present disclosure will become apparent from the following description of exemplary embodiments (with reference to the attached drawings).

### BRIEF DESCRIPTION OF THE DRAWINGS

FIG. 1 is a block diagram illustrating the overall configuration of a control system of a printing system.

FIG. 2 is a block diagram illustrating the flow of image data conversion processing.

FIG. 3 is a diagram illustrating in detail the overall configuration of a printing apparatus.

FIG. 4A illustrates a print setting UI operated by a user to set a print setting of the printing apparatus.

FIG. 4B illustrates a post-processing process selection UI for setting the post-processing process.

FIG. 5A illustrates a printing medium before printing.

FIG. 5B illustrates the printing medium after single-sided printing in a curled state.

FIG. 6A is a diagram illustrating the state of the printing medium discharged into a discharge tray.

FIG. 6B is diagram schematically illustrating the state of a preceding printing medium placed in the discharge tray being curled up and, in this state, a subsequent printing medium is discharged.

FIG. 7 is a diagram of the area near the discharge unit installed with a post-processing mechanism.

FIG. 8A is a diagram illustrating the direction that the sheet tends to curl.

FIG. 8B is a diagram illustrating the result of examining the relationship between the ejection amount of ink and the initial curling (curl) amount using the following method.

FIG. 9A is a diagram illustrating the relationship between printing time and curl amount.

FIG. 9B is a diagram illustrating the relationship between printing time and curl amount.

FIG. 10 is a diagram of a flowchart illustrating printing processing according to a first embodiment.

FIG. 11 is a diagram of a printing operation table.

FIG. 12A is a diagram for describing curling when there is no difference in the ink amount between the front and back sides.

FIG. 12B is a diagram for describing curling when there is a difference in the ink amount between the front and back sides.

FIG. 12C is a diagram illustrating the relationship between the difference in the ink amount between the front and back sides and the curl amount.

FIG. 13A is a diagram illustrating an example of a change recommendation UI 1301.

FIG. 13B illustrates a UI for receiving an alternative candidate print setting.

FIG. 14 is a diagram illustrating a flowchart of printing operation according to a second embodiment.

FIG. 15 is a diagram illustrating a UI for an anti-paper jam setting according to the second embodiment.

FIG. 16 is a diagram illustrating a paper jam occurrence information table.

FIG. 17 is a diagram of a flowchart illustrating printing processing according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

When a post-processing mechanism is installed in a discharge unit, as a result of the height of the discharge port decreasing, the paper tends to jam more often.

In light of such a situation, the present embodiment provides technology for reducing paper jam even when a post-processing mechanism is installed in a discharge unit.

### First Embodiment

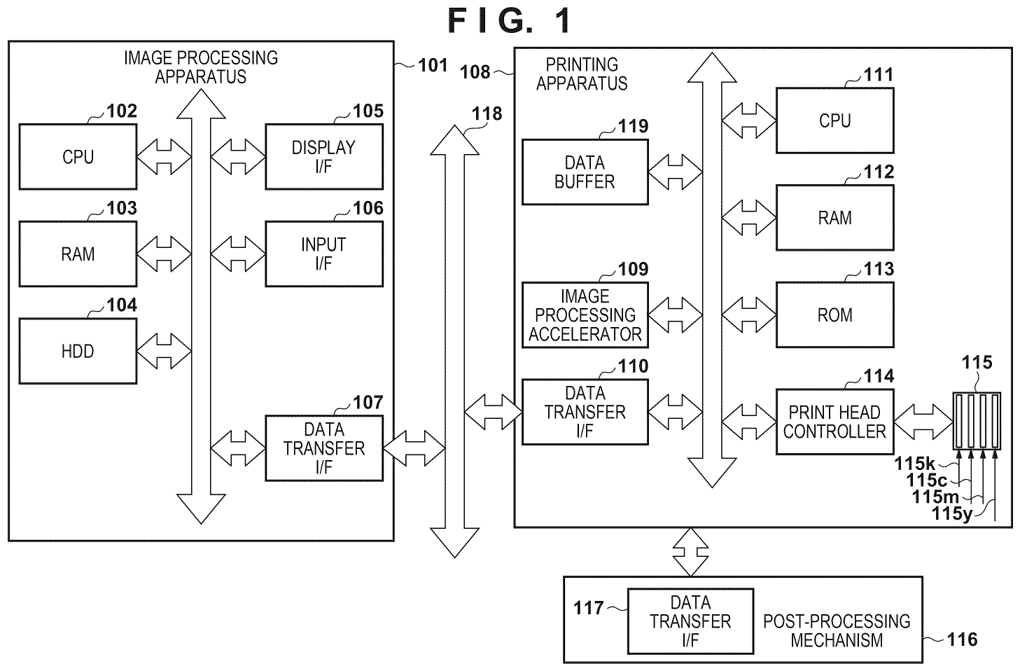

FIG. 1 is a block diagram for describing the overall configuration of a control system of a printing system according to the present embodiment. As illustrated in FIG. 1, the printing system includes an image processing apparatus 101, a printing apparatus 108, and a post-processing mechanism 116. The image processing apparatus 101 and the printing apparatus 108 are connected via a network 118 in a manner enabling information to be transmitted and received.

The image processing apparatus 101, on the basis of an instruction from a user or the like, generates data of an image for printing by the printing apparatus 108 and transmits the data to the printing apparatus 108. The image processing apparatus 101 is a computer such as a host personal computer (PC), a tablet PC, or the like. The image processing apparatus 101 includes a CPU 102, a RAM 103, an HDD 104, a display I/F 105, and input I/F 106, and a data transfer I/F 107.

The CPU 102 is an abbreviation of central processing unit and is processor such as a central processing unit. The image processing apparatus 101 may include, in addition to or instead of the CPU 102, a micro processing unit (MPU), a graphics processing unit (GPU), a quantum processing unit (QPU), or a similar processor. The CPU 102 reads out a program stored in the HDD 104, loads the program on the RAM 103 functioning as a working area, and executes various types of processing. Also, the CPU 102 executes various types of processing in accordance with commands received from the user via the input I/F 106 and a touch panel (not illustrated). For example, the CPU 102, in accordance with a command, executes a program stored in the HDD 104, generates image data printable by the printing apparatus 108, and transfers the image data to the printing apparatus 108. A part or all of the various types of processing executed by the CPU 102 may be implemented using one or more circuits such as an application specific integrated circuit (ASIC), a field programmable gate array (FPGA), or the like.

The RAM 103 is an abbreviation of random access memory and is a memory with high read and write speeds for data. The RAM 103 temporarily stores programs read out by the CPU 102 and temporarily stores data required to execute programs, data corresponding to program processing results, and the like.

The HDD 104 is an abbreviation of hard disk drive and is a non-volatile storage apparatus that can stored data without power being supplied. The HDD 104 stores programs, data required to execute programs, data corresponding to program processing results, and the like.

The display I/F 105 is an interface that connects to a display apparatus that displays images such as a liquid crystal display device, an organic electro luminescence (EL) display apparatus, or the like. The display I/F 105 outputs the image output by the CPU 102 to the display apparatus.

The input I/F 106 is an interface that connects to an input apparatus such as a keyboard, mouse, or the like for a user to input commands, data, and the like.

The data transfer I/F 107 is an interface that connects to the network 118. The data transfer I/F 107 outputs data output by the CPU 102 and the like to the printing apparatus 108, which is an external apparatus, via the network 118. Also, the data transfer I/F 107 receives the data transmitted by the external apparatus and outputs the data to the CPU 102 and the like via the network 118.

With the configuration described above, the image processing apparatus 101 executes predetermined processing in accordance with a program stored in the HDD 104 on the image data received from the printing apparatus 108 via the data transfer I/F 107. The image processing apparatus 101 displays the program processing result and various pieces of information on a display (not illustrated) via the display I/F 105.

The printing apparatus 108 prints an image on a printing medium such as paper on the basis of the image data transmitted by the image processing apparatus 101. The printing apparatus 108 is an inkjet printing apparatus and may be referred to as an inkjet printer. The printing apparatus 108 is configured to be installed with a post-processing mechanism that executes a post-processing process on a printing medium printed with an image. The printing apparatus 108 includes a CPU 111, a RAM 112, a ROM 113, an image processing accelerator 109, a data transfer I/F 110, a print head controller 114, a print head 115, and a data buffer 119. At least a part of the CPU 111, the RAM 112, the ROM 113, the image processing accelerator 109, the data transfer I/F 110, the print head controller 114, the print head 115, and the data buffer 119 is a computer and an example of an information processing apparatus.

The CPU 111 is an example of a control unit and is a processor also referred to as a central processing unit. The printing apparatus 108, in addition to or instead of the CPU 111, may also include an MPU, a GPU, a QPU, or a similar processor. The CPU 111 reads out a program stored in the ROM 113, loads the program on the RAM 112 functioning as a working area, and executes various types of processing. For example, the CPU 111, in accordance with a command from the user, executes a program stored in the ROM 113 and controls the printing apparatus 108 to print an image on a printing medium on the basis of the image data transmitted by the image processing apparatus 101. The CPU 111 directly or indirectly controls the post-processing mechanism. A part or all of the various types of processing executed by the CPU 111 may be implemented using one or more circuits such as an ASIC and an FPGA.

The RAM 112 is an example of a storage unit, is an abbreviation of random access memory, and is a memory with high read and write speeds for data. The RAM 112 temporarily stores programs read out by the CPU 111 and temporarily stores data required to execute programs, data corresponding to program processing results, and the like.

The ROM 113 is an abbreviation of read-only memory and is a non-volatile memory that can store data without power being supplied. The ROM 113 stores programs, data required to execute programs, and the like.

The image processing accelerator 109 executes image processing at high-speeds. The image processing accelerator 109 is a piece of hardware that can execute image processing at higher speeds than the CPU 111. The image processing accelerator 109 may be a GPU, for example. The image processing accelerator 109 is activated by the CPU 111 writing the parameters and data required for image processing to a predetermined address of the RAM 112 and executes a predetermined image processing on the data after the parameters and data have been loaded. However, the image processing accelerator 109 is not a necessary component, and a similar processing can be executed by the CPU 111.

The data transfer I/F 110 is an interface that connects to the network 118. The data transfer I/F 110 receives data such as the image data output by the image processing apparatus 101 via the network 118.

The print head controller 114 controls the print head 115 and prints an image on the basis of an instruction from the CPU 111 or the like.

The print head 115 discharges ink onto a printing medium and prints an image on the basis of the control by the print head controller 114. The print head 115 discharges pigment ink of four colors. The four colors are KCMY (black, cyan, magenta, and yellow). The print head 115 includes a plurality of nozzle arrays 115k, 115c, 115m, 115y each including a plurality of nozzles. The discharge amount of each nozzle is 4 (pL), for example.

The data buffer 119 temporarily stores data. The data buffer 119 temporarily stores the image data transmitted by the image processing apparatus 101, for example.

The post-processing mechanism 116 executes a post-processing process on a printing medium printed with an image. The post-processing mechanism 116 includes a data transfer I/F 117. The post-processing mechanism 116 is detachably installed in the printing apparatus 108. The post-processing mechanism 116 is connected to a member that discharges a printing medium with an image printed by the printing apparatus 108, for example. In a state with the post-processing mechanism 116 installed in the printing apparatus 108, the data transfer I/F 117 is connected to the printing apparatus 108 in a manner allowing data such as commands to be transmitted and received. The post-processing mechanism 116, in an installed state in the printing apparatus 108, executes the post-processing process on the basis of an instruction or the like from the CPU 111 of the printing apparatus 108 received via the data transfer I/F 117. The post-processing process includes at least one of various types of post-processing processes including a stapling process to bind a plurality of printing medium with a printed image, a hole punching process to punch open holes in the printing medium, a sorting process for shift sorting, and the like.

### Image Processing Flow

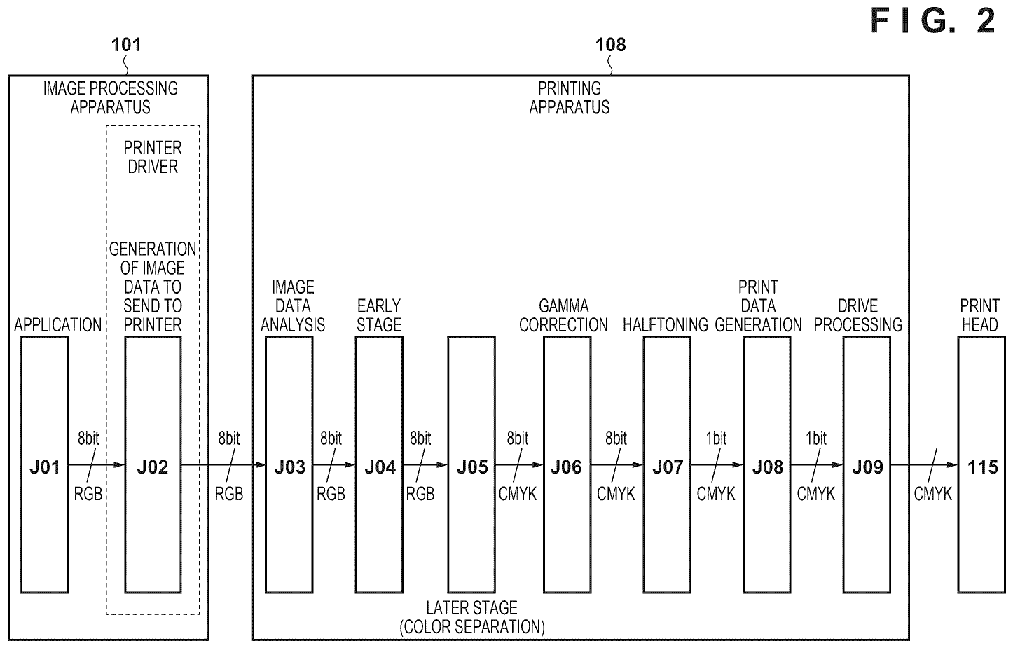

FIG. 2 is a block diagram illustrating the flow of image data conversion processing in the printing system according to the present embodiment. The image data conversion processing in the printing apparatus 108 will be described below.

The printing apparatus 108 according to the present embodiment prints using ink of four colors, cyan, magenta, yellow, and black. The print head 115 includes a nozzle array that discharges ink of the four colors. As illustrated in FIG. 2, each image process in the printing system is executed by the image processing apparatus 101 and the printing apparatus 108.

Programs that run on the operating system of the image processing apparatus 101 include applications, printer drivers, and the like. Applications and printer drivers are executed by the CPU 102. Examples of applications include applications for creating documents, applications for creating illustrations, and the like.

In application processing J01, the CPU 102 that executes the application generates image data corresponding to the image to be printed by the printing apparatus 108. The CPU 102 sends the image data generated in the application processing J01 to the printer driver.

In image data to send to printer generation processing J02, the CPU 102 executes the printer driver, generates image data, and transmits the image data to the printing apparatus 108. Specifically, the CPU 102 generates image data in a page-description language (PDL) format as image data. Hereinafter, image data in the PDL format will be referred to as PDL data. PDL is a page-description language. A known example of PDL is “PDF” from Adobe (registered trademark). PDL is widely used as an image format that can describe line and character vector data and not only bitmap. The CPU 102, by executing the printer driver, generates image data to send to printer of a PDL format from image data sent from an application. The CPU 102, by executing the printer driver, adds a header portion such as setting information relating to the printer set via a user interface (UI) of the image processing apparatus 101 and generates image data to send to printer. The CPU 102 controls the data transfer I/F 107 of the image processing apparatus 101 and transmits the image data to send to printer to the data transfer I/F 110 of the printing apparatus 108 via the network 118. The printing apparatus 108 stores the received image data in the data buffer 119.

In image data analysis processing J03, the CPU 111 (image processing unit) of the printing apparatus 108 analyzes the image data transmitted by the image processing apparatus 101. The CPU 111 sequentially reads out the PDL data from the data buffer 119. The CPU 111 interprets the render command included in the PDL data and develops the PDL data into raster image data with a format similar to bitmap. The CPU 111 stores the developed raster image data in the data buffer 119. The CPU 111 continues to execute image processing on the analyzed and developed raster image data.

The CPU 111 executes early stage processing J04 which is color conversion processing for color matching between models, later stage processing J05 which is color separation, gamma correction processing J06, halftoning processing J07 which is binary quantization, and print data generation processing J08. Here, each process will be simply described.

In the early stage processing J04, the CPU 111 executes color matching processing to match colors that are difference between models.

In the later stage processing J05, the CPU 111 executes color separation processing to convert the 8-bit data R, G, B obtained in the early stage processing J04 into color separated data (here, 8-bit data C, M, Y, K) corresponding to the combination of ink for reproducing the colors represented by the RGB data. Specifically, the CPU 111 uses a conversion table (for example, a three-dimensional look-up table (LUT)) in which the RGB data and the CMYK data corresponding to the ink are associated in a 1-to-1 relationship. The CPU 111 references the conversion table and converts the RGB data to CMYK data. For example, in the three-dimensional LUT, each value of R, G, and B represented by 8-bits (0 to 255) is associated in advance with a value of CMYK represented by 8-bits (0 to 255). The CPU 111, on the basis of the conversion table, converts image data of (R, G, B)=(0 to 255, 0 to 255, 0 to 255) to image data of (C, M, Y, K)=(0 to 255, 0 to 255, 0 to 255, 0 to 255). For example, the CPU 111 converts (R, G, B)=(0, 0, 0) to (C, M, Y, K)=(0, 0, 0, 255). The CPU 111 converts (R, G, B)=(255, 255, 255) to (C, M, Y, K)=(0, 0, 0, 0). The CPU 111 converts (R, G, B)=(0, 128, 0) to (C, M, Y, K)=(128, 0, 128, 0).

In the present embodiment, a plurality of conversion tables are preset and stored in the ROM 113. For example, at least two types of conversion tables are provided. The CPU 111 switches between the conversion table to use according to a predetermined condition. This will be described below in detail.

In the gamma correction processing J06, the CPU 111 executes tone value

conversion on the data of each ink color of the color separation data obtained in the later stage processing J05 which is color separation processing. Specifically, the CPU 111 uses a one-dimensional LUT corresponding to the tone characteristics of each color ink of the printing apparatus 108 to execute conversion so that the color separation data is linearly associated with the tone characteristics of the printing apparatus 108.

In the halftoning processing J07, the CPU 111 executes quantization processing to convert each piece of 8-bit color separation data C, M, Y, K into 1-bit data. In the present embodiment, the CPU 111 uses a binary dithering method to convert the 8-bit data of 256 tones to 1-bit data of 2 tones.

In the print data generation processing J08, the CPU 111 generates print data with print control information added to the print image data containing 1-bit dot data. The CPU 111 stores the generated print data in the data buffer 119.

In drive processing J09, the CPU 111 sequentially reads out the binary print data stored in the data buffer 119 and sends the print data to the print head controller 114. The print head controller 114 converts the 1-bit data of each color into a drive pulse of the print head 115 and outputs the drive pulse. In this manner, the print head 115 discharges ink at a predetermined timing.

### Printing Apparatus Details

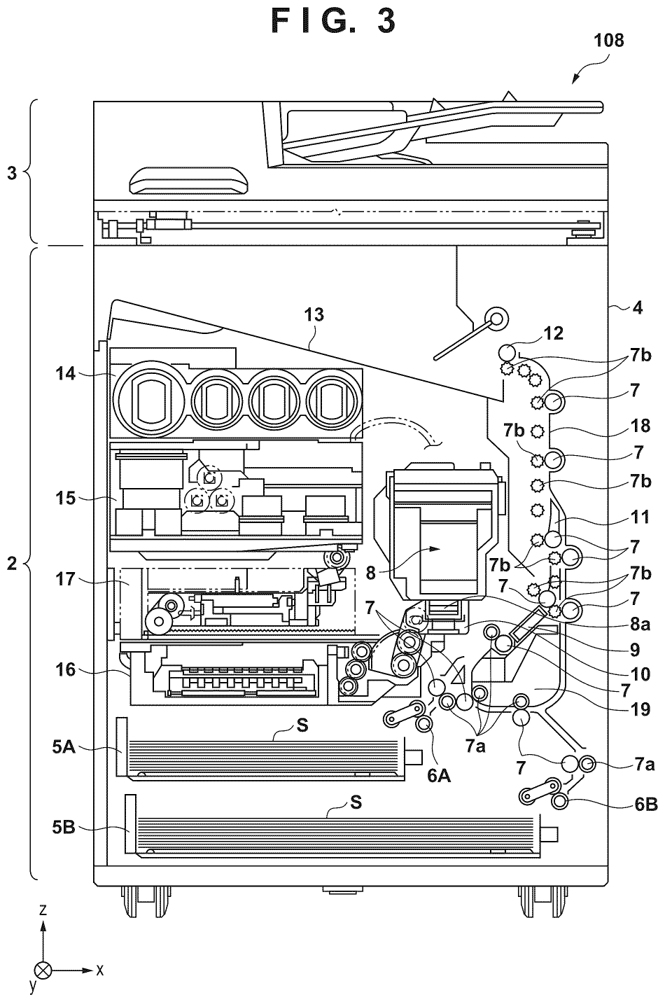

FIG. 3 is a diagram illustrating in detail the overall configuration of the printing apparatus 108 according to the present embodiment. The printing apparatus 108 will be described below in detail. Hereinafter, the xyz directions indicate the xyz direction indicated by the arrows at the bottom left of FIG. 3.

The printing apparatus 108 is a multi-function peripheral that executes various types of processing relating to image printing operations and image reading operations. The printing apparatus 108 includes a printing unit 2 and a scanner unit 3. The printing apparatus 108 executes various types of operations by separately or cooperatively driving the printing unit 2 and the scanner unit 3. FIG. 3 illustrates the printing apparatus 108 in a standby state in which neither a printing operation or a reading operation is being performed. Note that the printing apparatus 108 according to the present embodiment is a multi-function peripheral including both the printing unit 2 and the scanner unit 3, but in another embodiment, the scanner unit 3 may not be provided.

The scanner unit 3 includes an automatic document feeder (ADF) and a flat bed scanner (FBS). The ADF automatically feeds documents. The FBS reads (scans) documents automatically fed to it and documents placed on a platen of the FBS by the user.

The printing unit 2 includes a casing 4, a first cassette 5A, a second cassette 5B, a first feeding unit 6A, a second feeding unit 6B, one or more conveyance rollers 7, one or more pinch rollers 7a, one or more spurs 7b, a flapper 11, a discharge roller 12, a discharge tray 13, a guide 18, and an inner guide 19.

The casing 4 houses and holds the members of the printing unit 2.

The first cassette 5A and the second cassette 5B are detachably installed in the bottom portion of the casing 4 in the vertical direction. The first cassette 5A and the second cassette 5B house printing medium S such as cut sheets. The first cassette 5A houses relatively small printing medium up to the A4 size in a stack. The second cassette 5B houses relatively larger printing medium up to the A3 size in a stack.

The first feeding unit 6A is provided near the first cassette 5A. The second feeding unit 6B is provided near the second cassette 5B. The first feeding unit 6A and the second feeding unit 6B feed the housed printing medium separating them one at a time. When a printing operation is performed, one of the feeding units 6A and 6B selectively feeds the printing medium S from one of the cassettes 5A and 5B.

The conveyance rollers 7, the pinch rollers 7a, the spurs 7b, the flapper 11, the discharge roller 12, the discharge tray 13, the guide 18, and the inner guide 19 correspond to a conveying mechanism for conveying the printing medium S in a predetermined direction. Upstream and downstream used in the following description indication upstream and downstream with respect to the conveyance path of the printing medium S.

The plurality of conveyance rollers 7 are disposed along the conveyance path on the upstream side and the downstream side of a print head 8 and a platen 9. The conveyance rollers 7 are driving rollers that are rotationally driven by a conveyance motor.

The pinch rollers 7a are disposed on the downstream side of both the feeding units 6A and 6B. The pinch rollers 7a nip the printing medium S fed from the feeding units 6A and 6B together with the conveyance rollers 7. The pinch rollers 7a are driven rollers that rotate in conjunction with the rotation of the conveyance rollers 7.

The plurality of spurs 7b are disposed along the conveyance path on the downstream side of the print head 8 and the platen 9. The spurs 7b with the conveyance rollers 7 or the discharge roller 12 hold the printing medium S between them and convey the printing medium S.

The flapper 11 is a member for switching the direction in which the printing medium S is conveyed in the case of a double-sided printing operation in which an image is printed on both sides of the printing medium S.

The guide 18 is provided along the conveyance path of the printing medium S. The guide 18 guides the printing medium S conveyed by the conveyance rollers 7 and the like along the conveyance path.

The inner guide 19 is disposed near the pinch rollers 7a and includes a side surface that is curved as the member extends in the y direction. The inner guide 19 guides the printing medium S along the side surface.

The discharge roller 12 is disposed on the downstream side of the conveyance path downstream from the conveyance rollers 7. The discharge roller 12 is a driving roller that is driven by a discharge motor. The discharge roller 12 discharges the printing medium S conveyed along the conveyance path to the discharge tray 13.

The printing medium S discharged by the discharge roller 12 after the printing operation is complete is stacked in the discharge tray 13. The discharge tray 13 is an example of a discharge unit.

The printing unit 2 further includes the print head 8, the platen 9, an ink tank unit 14, an ink supply unit 15, and a maintenance unit 16.

The print head 8 according to the present embodiment is a full line type color inkjet print head. The print head 8 includes a plurality of discharge ports that discharge ink in accordance with the print data. The plurality of discharge ports are arranged to correspond with the width of the printing medium S in the y direction. When the print head 8 is in the standby position, a discharge port surface 8a of the print head 8 is orientated downward (−z direction) in the vertical as illustrated in FIG. 3 and is capped by a cap unit 10. When a printing operation is performed, the orientation of the print head 8 is changed by the CPU 111 so that the discharge port surface 8a is positioned opposite the platen 9.

The platen 9 includes a flat plate extending in the y direction and is disposed in the middle portion of the conveyance path. In a printing operation, the platen 9 is positioned opposite the discharge port surface 8a of the print head 8 and supports the printing medium S from the back surface for the printing operation to be performed by the print head 8.

The ink tank unit 14 stores the four colors of ink supplied to the print head 8.

The ink supply unit 15 is provided in the middle portion of the flow path connecting the ink tank unit 14 and the print head 8 and adjusts the pressure and the flow rate of the ink in the print head 8 within an appropriate range. In the present embodiment, a circulation ink supply system is used. Accordingly, the ink supply unit 15 adjusts the pressure of the ink supplied to the print head 8 and the flow rate of the ink collected from the print head 8 within an appropriate range.

The maintenance unit 16 includes the cap unit 10 and a wiping unit 17. The maintenance unit 16 causes the cap unit 10 and the wiping unit 17 to operate at a predetermined timing and executes maintenance for maintaining and recovering the discharge performance of the print head 8. The cap unit 10 operates at a predetermined timing to cap the discharge port surface 8a. The wiping unit 17 cleans the discharge port surface 8a of the print head 8.

### Post-Processing Mechanism

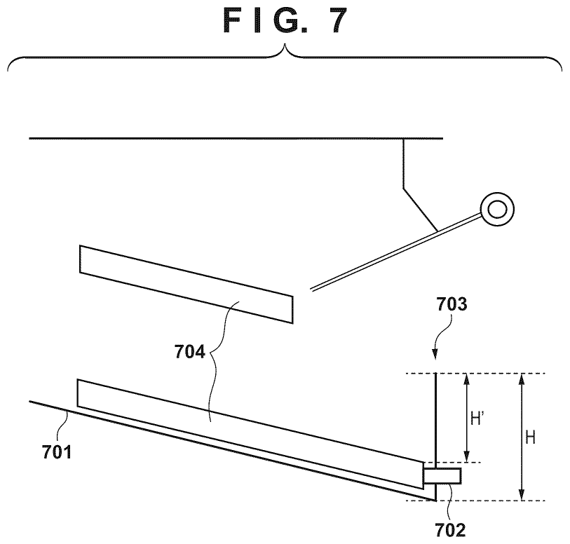

The post-processing mechanism can be installed at the discharge tray of the printing apparatus 108 or near the discharge tray. Accordingly, the user can use the post-processing process without increasing the footprint. FIG. 7 is a diagram of the area near the discharge unit of FIG. 3 installed with a post-processing mechanism 704.

The post-processing mechanism 704 is installed aligned with a discharge tray 701, and a sensor 702 can determine whether or not it is installed. The post-processing mechanism will now be described. The functions of the post-processing mechanism include a shift sort function, a punch function, and a staple function.

The shift sort function is a mechanism that shifts the paper stack for each set so that the paper stacks can be separated at each set after the finishing. The details will be described below, but after printing, the water content is applied to the media print surface side of the printing medium S and the hydrogen bonds of the media break causing swelling. This makes the printing medium S curl with the curve of the print surface side pointing upward. In this post-discharge curled state, the subsequent printing medium S is discharged onto the preceding printing medium S on the discharge tray. With no sorting, the left-right discharge positions are aligned, and the printing medium S may bump into each other without causing a paper jam. With shift sorting, the subsequent printing medium S runs into the preceding printing medium S with post-discharge curling with the curve on the lower side at the shifted position, and the pieces of printing medium S bump into each other. The collision between the printing medium S makes jamming more likely.

The staple function is a function for automatically stapling together the printing medium S. Regarding meeting material, proposal material, and the like, by using the staple function when material needs to be created by stapling together a plurality of sheets of the printing medium S, the amount of time taken to create the material can be greatly reduced. In the case of using the staple function, the bundle of the printing medium S is fixed with the offset unchanged, causing a bad appearance. Thus, there is a demand for better alignment. Also, the plurality of printing medium S needs to be put in the narrow opening of a stapler, and so even a small amount of curl may cause jamming.

The punch function is a function for opening a punch hole in the printed printing medium S. The opened punch hole is a hole for filing the printing medium S as a stack using rings or the like. In the case of filing, if the offset amount is large, the post-filing alignment of the printing medium S is degraded. Thus, there is a demand for better alignment. Also, the plurality of printing medium S needs to be put in the narrow opening of a puncher, and so even a small amount of curl may cause jamming.

### Print Settings

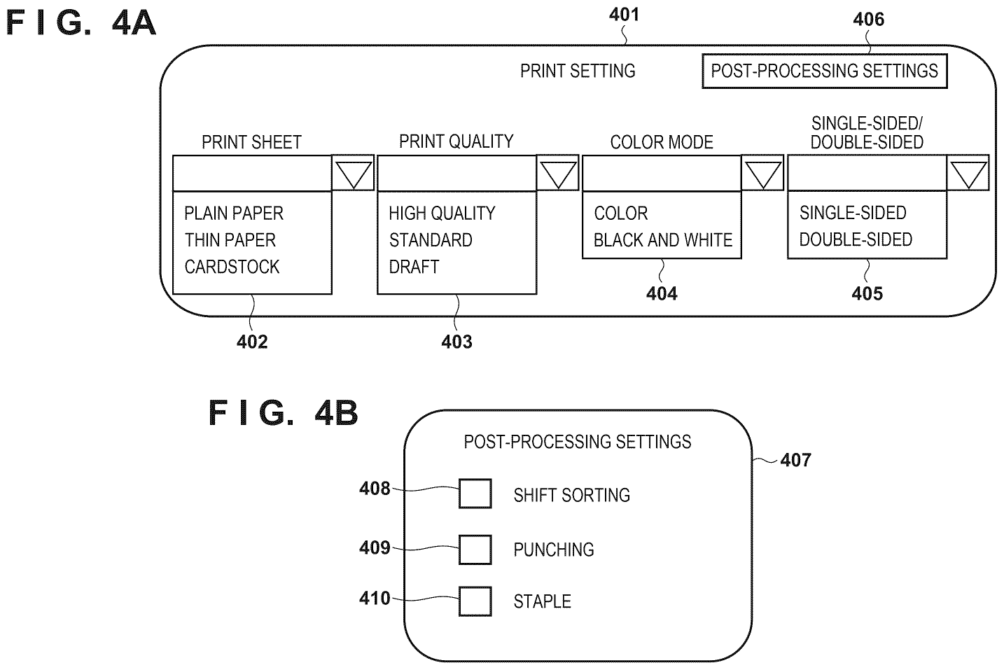

FIG. 4A illustrates a print setting UI 401 operated by the user to set the print setting of the printing apparatus. The print settings may also be referred to as printing settings. FIG. 4B illustrates a post-processing process selection UI 407 for setting the post-processing process. UI is an abbreviation for user interface.

As illustrated in FIG. 4A, the following selections are possible via the print setting UI 401 operated by the user when issuing print setting instructions to the printing apparatus 108. For example, the user selects, via the print setting UI 401, settings including a print sheet type selection 402, a print quality setting 403, a color mode 404, a single-sided/double-sided setting 405, and the like. Here, print sheet setting is where the printing medium such as plain paper, thin paper, cardstock, or the like is set. The print quality setting is where the different print quality or speeds such as high quality, standard, draft, and the like is set. The color mode setting is where either color printing or black and white printing is set. The single-sided/double-sided setting is where with single-sided printing or double-sided printing is designated.

### Post-Processing Settings

As illustrated in FIG. 4A, the print setting UI 401 includes a post-processing settings button 406. The post-processing settings button 406 can only be selected when it is determined that a post-processing mechanism is installed by the sensor 702. When the user selects the post-processing settings button 406, the post-processing process selection UI 407 is displayed as illustrated in FIG. 4B. The displayed post-processing process selection UI 407 includes a shift sorting checkbox 408, a punch function checkbox 409, and a staple function checkbox 410. The user selects the desired post-processing process via the post-processing process selection UI 407. The post-processing mechanism executes the post-processing process in accordance with the selection instruction.

### Why Curling Occurs

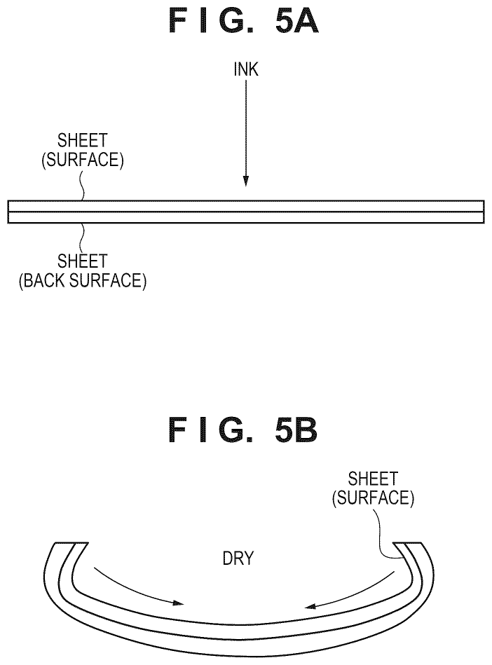

FIGS. 5A and 5B is a diagram schematically illustrating a printing medium at the time of single-sided printing in a curled state. FIG. 5A illustrates the printing medium before printing. FIG. 5B illustrates the printing medium after printing in a curled state.

Inkjet printing apparatuses commonly use a water-based ink. Thus, as illustrated in FIG. 5A, ink is discharged onto only one side of the sheet (printing medium). When an image is printed on only one side, the water content (ink solvent component) permeates into the fibers of the sheet. Accordingly, the front surface side of the sheet swells, and the sheet rises up on the front surface side. Thereafter, the water content permeated into the fibers of the sheet evaporates, and the front surface side contracts more than before printing. As a result, as illustrated in FIG. 5B, the sheet curls with the front surface which is the printed surface becoming the inner side.

The mechanism behind curling will now be described in further detail. When water content is applied to the sheet, the hydrogen bonds formed between the cellulose fiber of the sheet are broken. In other words, the water content being applied causes the cellulose to swell and a chemical phenomenon. At this time, the ink permeates in the depth direction of the sheet in a non-uniform manner, with the ink amount being less in deeper portions. Portions filled with ink, that is, the fiber at portions in contact with water, swell. Accordingly, a negative curl is caused with the surface where the water content is applied curls, curving to the opposite side. However, as the absorbed water content in the cellulose evaporates, the cellulose begins to contract and the hydrogen bonds that were broken reform. At this time, the hydrogen bonds reform not at the position where they were broken, but at a different position. Thus, positive curling occurs with the sheet curling gradually in the direction of the surface where the water content is applied.

Positive curling indicates a state in which the back surface bends to the surface side and the curve is pointing downward on the front surface side, and negative curling indicate a state in which the front bends to the back surface side and the curve is pointing upward on the front surface side. In particular, in the case of inkjet printing on plain paper or the like, positive curling can be problematic. If positive curling occurs, the discharged printing medium may be misaligned or a paper jam may occur.

### Curling and Jamming

The phenomenon of paper jamming when a printing medium with a curl is discharged will now be described in further detail.

When printing using an inkjet system, the amount of curling that occurs in a printing medium changes depending on the image printing duty cycle or the ejection amount of ink (applied amount). In particular, when the applied amount of ink is large, the printing medium after printing tends to curl greatly. Also, even in the case of low temperatures and low humidity, the curl tends to be large in a similar manner. Thus, if the printing medium with a large curl is continued to be conveyed as is and discharged to the discharge tray of the printing apparatus, the printing medium changes from a state in which the curl in restricted in the conveying path to a state in which the restriction is lifted. This makes the curl of the printing medium larger. Alternatively, if the printing medium is discharged to the discharge tray with the curl of the printing medium in an unstable state, the printing medium may deform greatly thereafter.

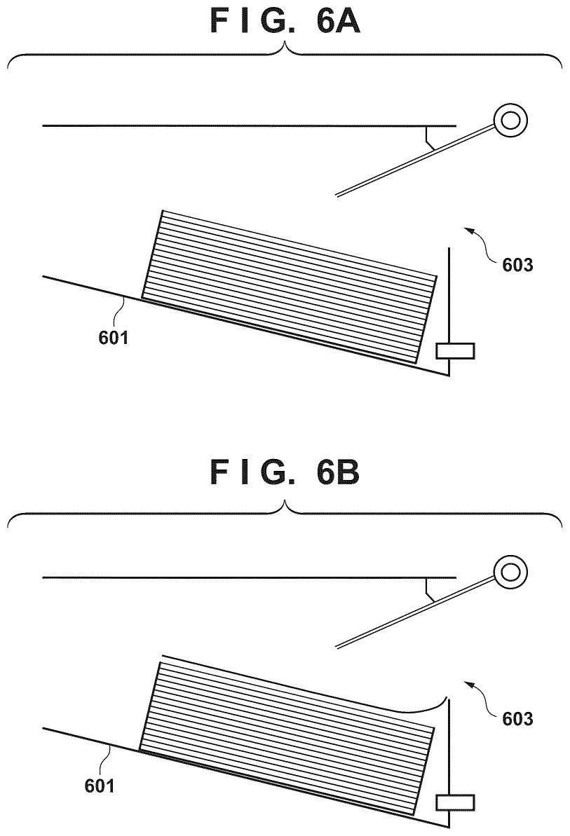

FIGS. 6A and 6B are diagrams for describing deformation of the printing medium in the discharge tray. FIG. 6A is a diagram illustrating the state of the printing medium discharged into the discharge tray. FIG. 6B is diagram schematically illustrating the state of the preceding printing medium placed in the discharge tray being curled up and, in this state, a subsequent printing medium is discharged.

In a case where the printing medium does not have a curl as illustrated in FIG. 6A, even if the preceding printing medium is placed in the discharge tray, the subsequent printing medium discharged from a discharge port 603 does not come into contact with the preceding printing medium.

In a case where the subsequent printing medium is discharged from the discharge port 603 with the preceding printing medium placed on a discharge tray 601 curled up as illustrated in FIG. 6B, the subsequent printing medium comes into contact with the preceding printing medium. As a result, the subsequent printing medium is pushed upward and deforms, causing a paper jam.

If the curl of the preceding printing medium decreases over time to a height lower than the discharge position and stays in this state, the subsequent printing medium is discharged without coming into contact with the preceding printing medium, and a paper jam does not occur.

### Post-Processing Mechanism and Paper Jam

A paper jam in the case of a post-processing mechanism will now be described using FIG. 7. A height H indicates the height from the lower end of a discharge port 703 before the post-processing mechanism 704 is installed to the discharge tray 701. A height H′ indicates the height from the lower end of the discharge port 703 after the post-processing mechanism 704 is installed to the discharge position of the post-processing mechanism 704. As can be seen from FIG. 7, by installing the post-processing mechanism 704, the height H′ for stacking at the discharge unit is smaller. As described above, printing may cause curling to occur. In a case where the post-processing mechanism 704 is installed, since the stack height H′ is smaller, the curl amount needs to be reduced more than in a case where the post-processing mechanism 704 is not installed to make paper jam less likely to occur.

### Ejection Amount and Curling

When the amount of water content applied per unit area of the sheet surface is large, the permeation depth of the water content into the sheet surface is deep. Since the hydrogen bonds in the sheet surface depth direction are broken and the number of fibers involved in curling are increased, we know that the degree of curling increases according to the ejection amount.

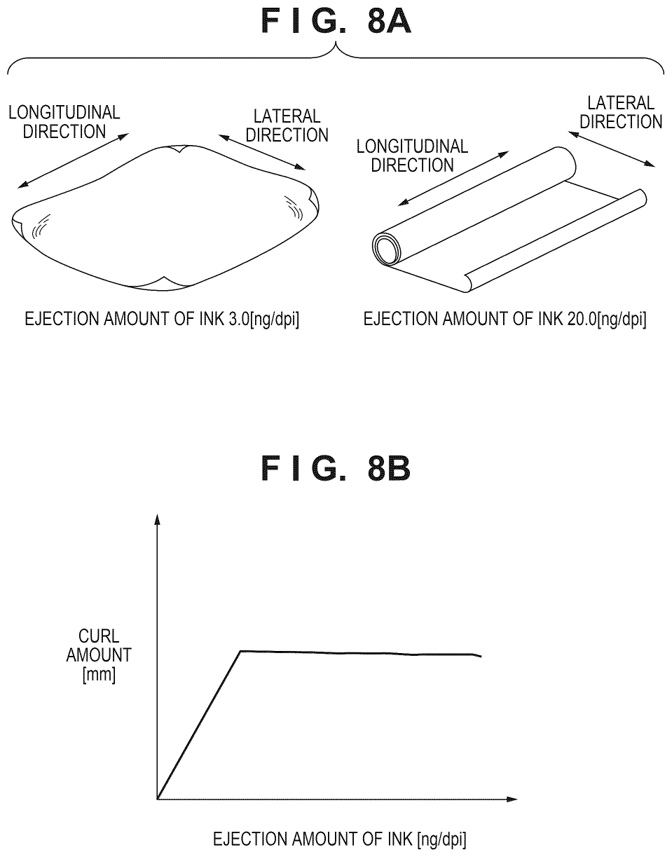

The relationship between the ejection amount of ink and the curl amount will be described in detail below. FIGS. 8A and 8B are diagrams illustrating the relationship between the ejection amount of ink and curling.

FIG. 8A is a diagram illustrating the direction that the sheet tends to curl. As described above, paper, which is a printing medium, has a fiber direction (also referred to as the grain of the paper). Here, the paper according to the present embodiment is made with the fibers aligned in the longitudinal direction. In this case, the paper is more likely to curl in the lateral direction. In particular, when the ejection amount of ink is small (for example, 3.0 ng/dpi), the curled state in the longitudinal direction and the curled state in the lateral direction are roughly the same. However, when the ejection amount of ink is large (for example, 20.0 ng/dpi), curling in the lateral direction tends to occur more than in the lateral direction.

FIG. 8B is a diagram illustrating the result of examining the relationship between the ejection amount of ink and the initial curling (curl) amount using the following method.

An inkjet printing apparatus is used as a printing apparatus, a solid color is printed on a plain paper at a constant ink amount, and the curl amount is measured immediately after the plain paper is discharged from the printing apparatus. In the curl amount measurement, the time when printing ends is defined as 0, after discharge, the printed surface is laid face down, the maximum height (H) of a back curl in which the ends of the paper curl up is measured at four points, and the average value is obtained and evaluated.

As can be seen from FIG. 8B, at a region where the ejection amount of ink is low, the curl amount increases as the ejection amount of ink increases. However, when the ejection amount of ink increases to a certain level, the curl amount becomes a substantially constant value.

The reason for this behavior is that the curling is determined by the difference in the elongation (stretching) of the paper between the front and back sides. Thus, while the ejection amount of ink is small, the paper elongation is great and the curl amount gradually increases. However, when the ejection amount of ink exceeds a certain amount, the water content amount permeating into the paper increases, and the difference in the elongation (stretching) of the paper between the front and back sides actually decreases, making the curl amount stop changing.

### Speed and Curling

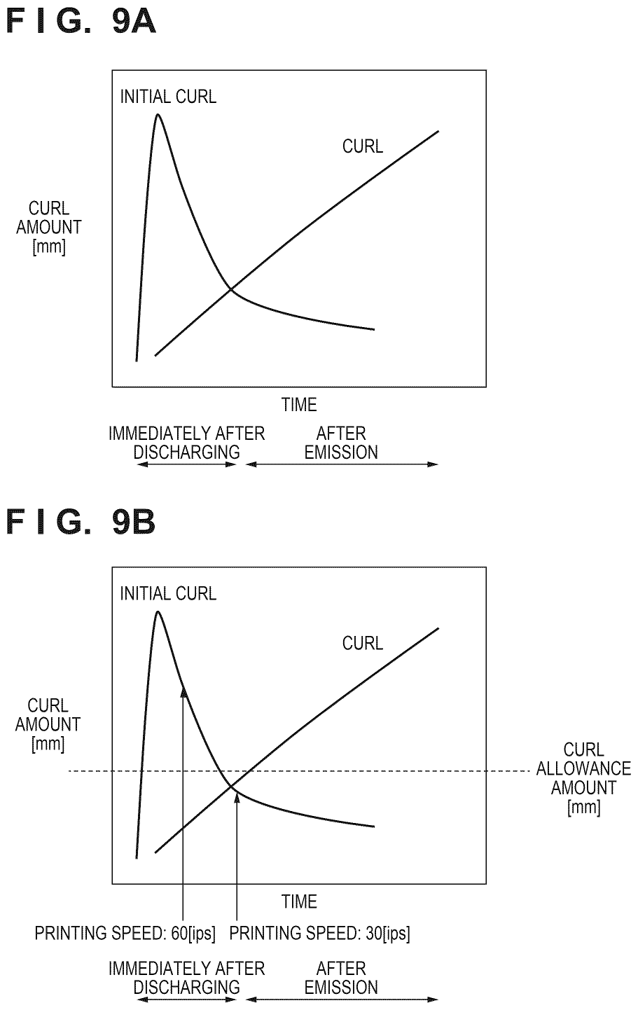

The relationship between the post-printing elapsed time and the curl amount will be described in detail below. FIGS. 9A and 9B are diagrams illustrating the relationship between the printing time and the curl amount.

FIG. 9A is a diagram illustrating the relationship between the post-printing elapsed time and the curl amount. In the schematic diagram, the horizontal axis represents the amount of time that has elapsed since ink has been applied, and the vertical axis represents the curl amount. The initial curl amount is the amount of curl from the print surface rising up due to the paper fibers swelling in reaction to the ink water content immediately after printing. The final curl amount is the amount of curl from the print surface being on the inner side due to the water content in the sheet evaporating and the surface shrinking.

The method for measuring the curl amount is similar to that described above and is performed by printing a solid color on a plain paper at a constant ink amount and measuring the change amount from immediately after the plain paper is discharged from the printer.

As can be seen from FIG. 9A, the initial curl amount immediately after ink is applied is large, and as time passes, the initial curl amount decreases. However, the final curl amount shows a tendency to increase as time passes. The reason for this behavior is that immediately after printing, the sheet curls with the front surface side rising up due to swelling on the front surface side of the sheet. Thereafter, the water content that permeated into the sheet evaporates, and the front surface contracts more than before printing, causing the sheet to curl with the print surface becoming the inner side.

An example of a method for solving this problem includes delaying the discharge of paper until the maximum value of the initial curl amount of the preceding printing medium is lower than the position of the discharge port of the discharge tray inside the printing apparatus. This suppresses paper jamming due to contact with the subsequent printing medium. Also, the paper is preferably discharged before the final curl amount increases above a predetermined curl allowance amount described below. In other words, the paper may be discharged in a time period in which the initial curl amount and the final curl amount are equal to or less than the curl allowance amount.

FIG. 9B is a diagram illustrating the result of examining the relationship between the printing speed and the curl amount using the following method. The printing speed may also be referred to as the print speed. In the schematic diagram, the horizontal axis represents the amount of time that has elapsed since ink has been applied, and the vertical axis represents the curl amount. Note that the immediately after discharge of ink and after discharge of paper displayed below the horizontal axis are of the draft mode.

Also, curl amount indicated is in the case of printing with the printing speed according to the present embodiment being 60 (ips) in standard mode and 30 (ips) in draft mode. It can be seen that in standard mode, the initial curl amount is greater than the curl allowance amount indicated by the 60 (ips) arrow. The 60 (ips) arrow indicates the paper discharge time in standard mode.

For example, in a case where printing is continued in the standard mode without changing the printing speed, depending on the ejection amount of ink of the print sample, the initial curl amount at the time of paper discharge exceeds the curl allowance amount. Thus, the subsequent printing medium comes into contact with the preceding printing medium, causing a paper jam.

If the initial curl amount of the preceding printing medium decreases over time to a height lower than the discharge position and stays in this state, the subsequent printing medium is discharged without coming into contact with the preceding printing medium, and a paper jam does not occur.

By decreasing the printing speed, the amount of time from the start of printing to paper discharge can be extended, which can help suppress the initial curl amount after paper discharge. In other words, in the draft mode with a slow printing speed, as indicated by the 30 (ips) arrow, when the paper is discharged, the initial curl amount is less than the curl allowance amount.

Accordingly, the printing speed may be set from the relationship between the printing speed described above and the curl amount.

Printing Operations when Setting Post-Processing Process Function

An example of operations performed regarding the installation of a post-processing mechanism and the decrease of curling when setting the post-processing process will be described, building on what has been described above.

As described above, installing a post-processing mechanism makes the discharge port narrower, which makes paper jams more likely. Thus, the curl amount after printing needs to be decreased more in the case of the post-processing mechanism being installed than in the case of the post-processing mechanism not being installed. For example, in an example of a method for reducing the curl amount, the CPU 111 may reduce the printing duty cycle. The printing duty cycle may be the density of the image printed on the printing medium, for example. In this case, the CPU 111 may display a UI warning that the print density will be reduced if the printing duty cycle is reduced. Examples of a method for reducing the curl amount include a method in which the CPU 111 performs adjustment to reduce the printing speed (print speed) as described above and a method in which the CPU 111 performs adjustment to extend the printing time (print time). At this time, the printing speed and the printing time can be adjusted by changing the waiting time during printing, changing the carriage scanning speed, or increasing the length of the print path. In a case where the curl amount is reduced by increasing the printing time, the CPU 111 may perform adjustment to increase the waiting time during printing. As a method for reducing the curl amount, reducing the applied amount of ink can also be performed as described above. In a case where the post-processing process is set, the curl amount can be reduced by executing these methods. Also, a combination of these methods may be used to reduce paper jams.

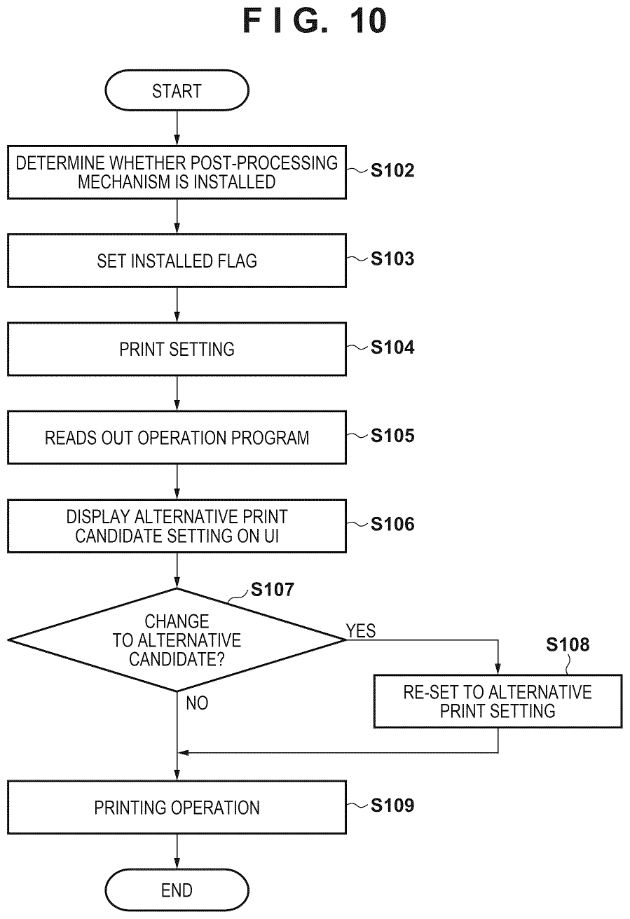

Building on what has been described above, the operations of the printing apparatus 108 when a post-processing process is applied will now be described. FIG. 10 is a diagram of a flowchart illustrating the printing processing of the printing apparatus 108.

In step S102, the CPU 111 determines whether or not a post-processing mechanism is installed. For example, the CPU 111 may determine this on the basis of a detection signal from the sensor 702 illustrated in FIG. 7.

In step S103, the CPU 111 sets a post-processing mechanism installed flag held in the RAM 112. Here, the installed flag being ON indicates that a post-processing mechanism is installed, and OFF indicates that a post-processing mechanism is not installed. Thus, in a case where the CPU 111 determines that a post-processing mechanism is installed on the basis of a detection signal from the sensor 702, the installed flag is set to ON. On the other hand, in a case where the CPU 111 determines that a post-processing mechanism is not installed, the installed flag is set to OFF. Note that in a case where the installed flag in ON, the user can select the post-processing settings button 406 in the print setting UI 401.

In step S104, the CPU 111 displays the print setting UI 401 and receives a print setting instruction from the user. In a case where the installed flag is ON, the CPU 111 displays the post-processing settings button 406 on the print setting UI 401. In a case where the user selects the post-processing settings button 406, the CPU 111 switches the display to the post-processing process selection UI 407. The CPU 111 receives a selection instruction of the post-processing process selected by the user on the post-processing process selection UI 407. The CPU 111 stores the received print setting in the RAM 112.

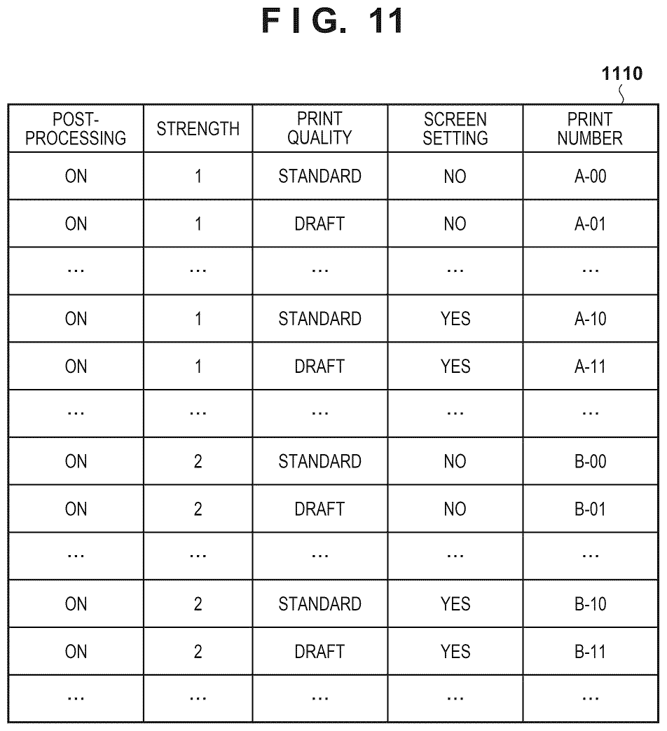

In step S105, in accordance with the print setting obtained in step S104, the CPU 111 references a printing operation table 1110 of the ROM 113, reads out the corresponding printing operation program, and loads this on the RAM 112. In this manner, the CPU 111 executes a printing operation in accordance with the user print setting. FIG. 11 is a diagram of the printing operation table 1110. The printing operation table 1110 includes a print number indicating a printing operation associated with a combination of post-processing and a print setting. The print setting includes anti-curling strength, print quality, double-sided setting, and the like. On the basis of the print number indicated in the printing operation table 1110, the CPU 111 reads out the desired printing operation program and performs the printing operation.

In step S106, the CPU 111 receives the print setting. For example, the CPU 111 displays a print setting alternative candidate for reducing the curl as a post-processing setting together with the normal print setting and displays a screen for receiving the print setting of the alternative candidate as the post-processing setting. The print setting alternative candidate will be described below. The print setting of the alternative candidate is a setting for discharging the paper with reduced curling of the printing medium and is an example of a second print setting. A normal print setting other than the alternative candidate print setting is an example of a first print setting.

### Print Setting and Print Ink Amount

Regarding the alternative print candidate setting, print settings and printing time will be described using FIG. 11.

As illustrated in FIG. 11, the print number of a print mode with an anti-curling strength of “1”, a print quality of “standard”, and a double-sided setting of “no” is “A-00”. The print number of a print mode with an anti-curling strength of “1”, a print quality of “draft”, and a double-sided setting of “no” is “A-01”.

In a case where the ink application amount of the printing operation of print number A-01 is set lower than the ink application amount of the printing operation of the print number A-00, the printing operation of print number A-01 is better at suppressing the curl amount. For example, in the case of print number A-00, printing may be set to be performed with an ink application amount of 10.0 ng/600 dpi, and in the case of print number A-01, printing may be set to be performed with an ink application amount of 5.0 ng/600 dpi.

The print number of a print mode with an anti-curling strength of “2”, a print quality of “standard”, and a double-sided setting of “no” is “B-00”, and the print number of a print mode with an anti-curling strength of “2”, a print quality of “draft”, and a double-sided setting of “no” is “B-01”. In a case where the ink application amount of the printing operation of print number B-00 is set lower than the ink application amount of the printing operation of the print number A-00, the print number B-00 is better at suppressing the curl amount than the print number A-00 set with an anti-curling strength of “1”. For example, the ink application amount of print number B-00 is 8.0 ng/600 dpi. In a case where the ink application amount of the printing operation of print number B-01 is set lower than the ink application amount of the printing operation of the print number A-01, the print number B-01 is better at suppressing the curl amount than the print number A-01 with an anti-curling strength of “1”. For example, the ink application amount of print number B-01 is 3.0 ng/600 dpi.

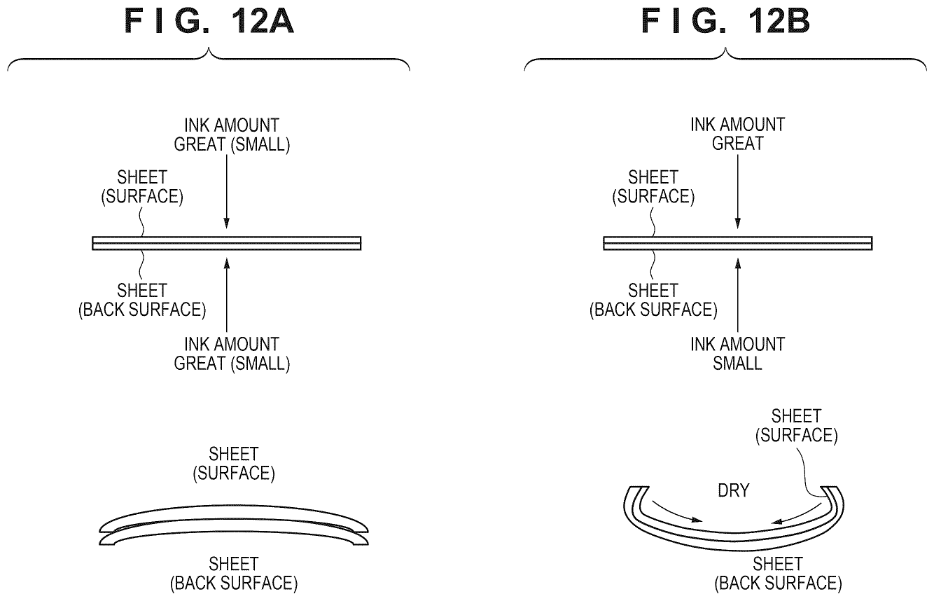

Here, curling in the case of double-sided printing will be described. FIGS. 12A to 12C are diagrams for describing curling of the printing medium when double-sided printing is performed. FIG. 12A is a diagram for describing curling when there is no difference in the ink amount between the front and back sides. FIG. 12B is a diagram for describing curling when there is a difference in the ink amount between the front and back sides. FIG. 12C is a diagram illustrating the relationship between the difference in the ink amount between the front and back sides and the curl amount. In FIG. 12C, the horizontal axis represents the difference in the ink amount between the front and back sides (ng/dpi), and the vertical axis represents the curl amount (mm).

As illustrated in FIG. 12A, in a case where the difference in the ink amount between the front and back sides is small, the difference in the swelling of the cellulose between the front and back sides of the printing medium is small. Thus, the curl amount is small. On the other hand, as illustrated in FIG. 12B, in a case where the difference in the ink amount between the front and back sides is large, the difference in the swelling of the cellulose between the front and back sides of the printing medium is large. Thus, the curl amount is large. As illustrated in FIG. 12C, when the difference in the ink amount between the front and back sides of the printing medium is large, the curl amount is large. However, if the difference in the ink amount is equal to or greater than a certain value, the curl amount hardly changes. In other words, compared to single-sided printing, double-sided printing produces a smaller curl amount due to the larger the difference in the ink amount between the front and back sides meaning the larger the curl amount. Thus, compared to single-sided printing, paper jams tend to occur less with double-sided printing.

Print Setting and Printing Speed

For print number A-00, the printing time is set to t (sec), for print number A-01, the printing time is set to s (sec), for print number B-00, the printing time is set to t′ (sec), and for print number B-01, the printing time is set to s′ (sec).

t′ (sec)>t (sec) is true. Adjustment of the printing speed can be performed by adjusting the waiting time during printing or the carriage scanning speed or by increasing the length of the print path. When the anti-curling strength is set to be increased, the printing speed is reduced, and the curl amount can be suppressed to prioritize alignment.

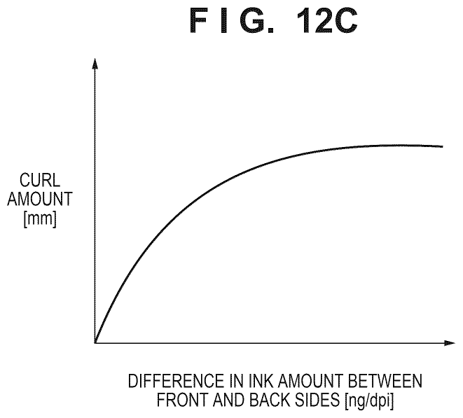

Returning to FIG. 10, as described above, in step S106, the CPU 111 displays a change recommendation UI 1301 for recommending a change to a print setting that prioritizes alignment. A print setting that prioritizes alignment is an example of a setting for discharging paper in a state with reduced paper jamming. FIGS. 13A and 13B are diagrams illustrating a UI for the user to select to change to an anti-paper jam print setting. FIG. 13A is a diagram illustrating an example of the change recommendation UI 1301. As illustrated in FIG. 13A, the change recommendation UI 1301 includes a message requesting a selection as to whether change or not, a button 1302 for issuing an instruction to change to an alternative candidate, and a button 1303 for issuing an instruction to not change to an alternative candidate. Note that the message requesting a selection as to whether to change or not may prompt the user to change to an alternative candidate print setting.

In step S107, the CPU 111 determines whether or not to change to an alternative candidate with the change recommendation UI 1301 in a displayed state. If the user presses the change button 1302, the CPU 111 determines to change to an alternative candidate and proceeds to step S108. On the other hand, when the user presses the no change button 1303, the CPU 111 keeps the print setting of step S104 and proceeds to step S109.

In step S108, the CPU 111 re-sets the print setting to an alternative print setting. Note that the CPU 111 may display the print setting UI 401 of FIG. 4A with the print quality selected as draft and make the user select an alternative print setting for the user to confirm the print setting. Also, as illustrated in FIG. 13B, the CPU 111 may display a print setting UI 1305 indicating an alternative candidate print setting for discharging paper with reduced curl and may receive a change to the alternative print setting from the user. FIG. 13B illustrates a UI for receiving the alternative candidate print setting. The print setting UI 1305 includes a radio button 1306 for selecting draft mode, a radio button 1307 for selecting black and white mode, a radio button 1308 for selecting double-sided mode, a radio button 1309 for selecting not to change the print setting, and an OK button 1310. When the user selects a radio button and presses the OK button 1310, the CPU 111 re-sets the alternative candidate print setting on the basis of the selected radio button. For example, as illustrated in FIG. 13B, in a case where the user selects the double-sided mode, the CPU 111 selects a print setting with a high anti-curling strength (for example, 2) and is the same as the user setting for the other settings from the printing operation table 1110. The CPU 111 re-sets the print setting as the alternative print setting.

In step S109, the CPU 111 executes the operation program and prints an image on a printing medium on the basis of the set print setting.

In the example described above, the draft mode is set as a print setting for prioritizing alignment. However, the alternative print setting for discharging paper with reduced curling is not limited to the draft mode, and any mode, such as an eco mode, a draft mode, a black and white mode, and the like, that has a small ink amount and suppresses curling to enable printing with good alignment can be used as the alternative print setting. Note that the printing speed reduction amount and ink reduction amount may be changed depending on the post-processing process type and combination of types. For example, if alignment is most important for the stapling processing from among the post-processing processes, instead of executing shift sorting processing, further reducing the speed, further reducing the ink application amount, and the like may be performed. For example, in a case where shift sorting processing is applied, the CPU 111 sets the anti-curling strength in FIG. 11 is “1”. On the other hand, in the case of stapling processing for which alignment is most important, the CPU 111 may set the anti-curling strength of FIGS. 11 to “2”.

According to the present embodiment, with the configuration described above, even if a post-processing process is set, the rate of paper jamming can be reduced.

Specifically, the CPU 111 of the printing apparatus 108 according to the first embodiment is configured to re-set the print setting that one that can suppress curling in a case where a post-processing mechanism is installed at the discharge tray 13. Thus, according to the first embodiment, even in a case where the height H′ of the discharge position is smaller than when nothing is installed, curling can be suppressed when paper is discharged. Thus, the preceding printing medium can be suppressed from coming out from the discharge port 703. As a result, according to the first embodiment, even in a case where a post-processing mechanism is installed at the discharge tray 13, the subsequent printing medium can be prevented from coming into contact with the preceding printing medium.

This can suppress paper jamming.

According to the first embodiment, in a case where the user selects a setting for suppressing curling from the UI 1301 and 1305 displayed, this print setting for suppressing curling is switched to and the printing operation is executed. This allow the user's desired printing operation to be realized.

### Second Embodiment

In the first embodiment described above, a post-processing mechanism is installed, and a recommended print setting mode for reducing the curl amount is displayed via a UI to the user who selected a post-processing setting. In the present embodiment, an example will be described of a UI displayed after a paper jam has occurred during repeated printing by the user.

Hereinafter, similar configurations to that in the first embodiment will not be described, and the actual operations will be described.

### Display Anti-Jamming Priority Print Mode Each Time a Jam Occurs

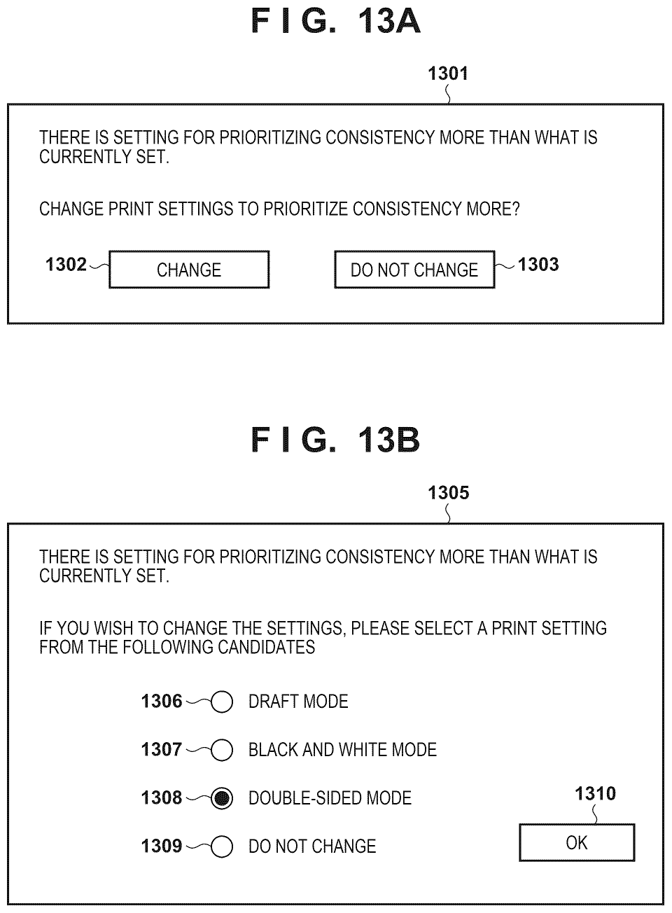

The actual flow will be described using FIG. 14. FIG. 14 is a diagram illustrating a flowchart of printing operation according to the second embodiment. In the present embodiment, an occurrence information table indicating whether or not a paper jam of the printing medium has occurred is stored, and paper jam occurrences are determined on the basis of the occurrence information table. In the present embodiment, on the basis of the determination result, a UI for receiving a print setting for suppressing curling is displayed. The process of installing the post-processing mechanism and the process of using a sensor to detect whether a post-processing mechanism is installed are similar to that described in the first embodiment. The following processing will now be described.

First, in step S201, the CPU 111 displays the print setting UI 401 and receives a print setting instruction from the user. Here, in a case where the user presses the post-processing settings button 406, the CPU 111 may display the post-processing process selection UI 407 and may receive the post-processing process setting from the user.

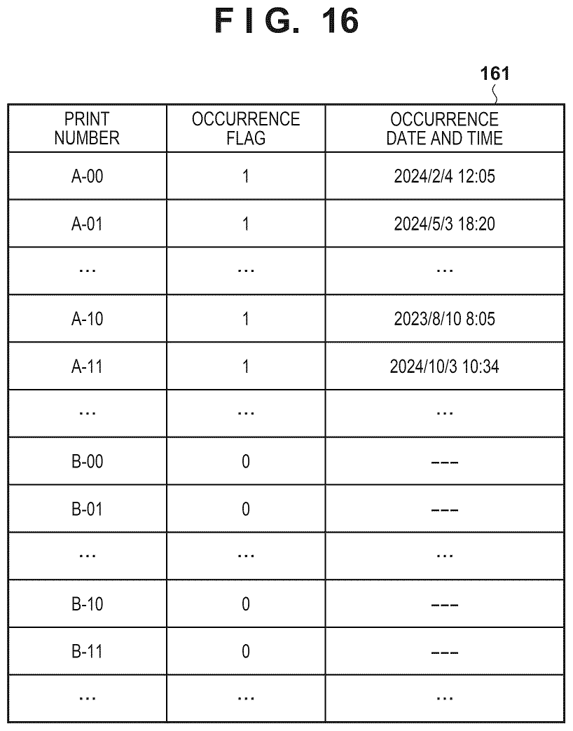

In step S202, the CPU 111 determines whether or not a paper jam has occurred in the most recent printing. FIG. 16 illustrates a paper jam occurrence information table 161. The occurrence information table 161 is a table indicating information relating to paper jam occurrences. The occurrence information table 161 includes a print number and an occurrence flag and occurrence date and time associated with the print number. The occurrence flag indicates whether or not a paper jam has occurred in the printing operations of the print number. If the occurrence flag is “1”, this indicates that a paper jam has occurred. If the occurrence flag is “0”, this indicates that a paper jam has not occurred. Note that even if an occurrence flag indicates that a paper jam has occurred before, thereafter, if paper jams have not occurred in the printing operations of the same print number, the CPU 111 may set the occurrence flag to “0”. The occurrence date and time indicates the date and time of the most recent paper jam. For example, for each printing operation, the CPU 111 may update and hold the occurrence flag and occurrence date and time of the corresponding print number. In a case where the CPU 111 determines that a paper jam has not occurred on the basis of the occurrence information table 161, the CPU 111 proceeds to step S204. In a case where the CPU 111 determines that a paper jam has occurred, the CPU 111 proceeds to step S203.

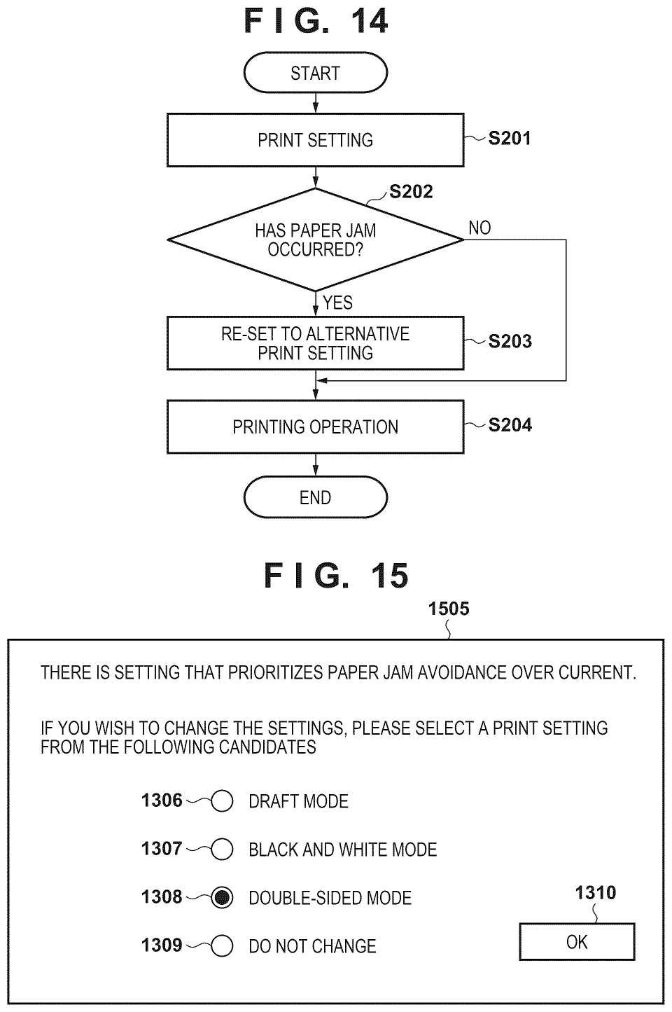

In step S203, the CPU 111 displays a print setting UI 1505 illustrated in FIG. 15 including a print setting recommended for suppressing paper jams. FIG. 15 is a diagram illustrating a UI for an anti-paper jam setting according to the second embodiment. In other words, the CPU 111 displays the print setting UI 1505 on the basis of the paper jam occurrence determination result. Here, the printing operation table 1110 for anti-curling illustrated in FIG. 11 is held in the ROM 113 in advance. The printing operation table 1110 of FIG. 11 is similar in terms of content to that described in step S106 in the first embodiment. The CPU 111 references the printing operation table 1110 and displays the recommended print setting on the UI. For example, in a case where a print setting with an anti-curling strength of “1” has been received from the user in step S201, the CPU 111 displays the print setting UI 1505 illustrated in FIG. 15 including an alternative candidate print setting with an anti-curling strength of “2” on the basis of the printing operation table 1110. The CPU 111 receives an alternative candidate print setting from the user via the print setting UI 1505. The CPU 111 re-sets the received alternative candidate print setting as the new print setting. Note that the CPU 111 re-sets the print setting on the basis of the print number of the printing operation table 1110.

In step S204, the CPU 111, on the basis of the print setting set via the print setting UI 401 of FIG. 4A and the print setting UI 1505 of FIG. 15, reads out the printing operation program and performs the printing operation. Here, in step S203, in a case where the print setting is re-set to a print setting for suppressing paper jams, the CPU 111 performs the printing operation using the re-set print setting.

In this manner, according to the present embodiment, in a case where a paper jam has occurred in the most recent printing, the CPU 111 changes the print setting as a measure against paper jamming. Thus, the rate of paper jams from the next printing after the printing in which the paper jam occurred onward can be reduced in accordance with the printing environment and the print setting used by the user.

### Third Embodiment

In the embodiments described above, the user sets the print setting to a print setting with a reduced curl amount before a paper jam occurs. In the present embodiment described herein, the print setting is re-set to a print setting for suppressing the curl amount when a paper jam occurs during a printing operation.

Hereinafter, similar configurations to that in the embodiments described above will not be described, and the actual operations will be described.

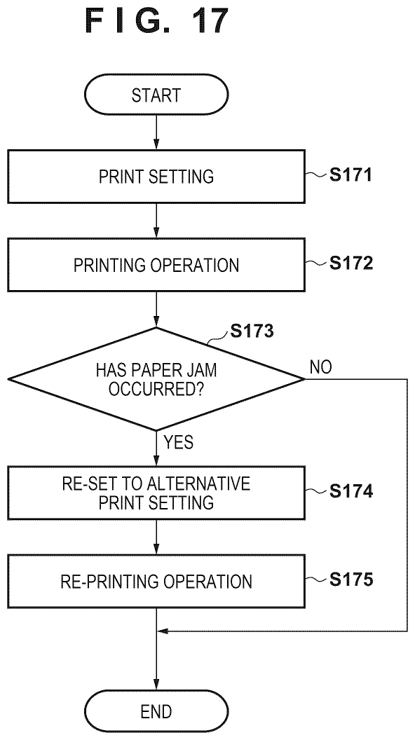

FIG. 17 is a diagram of a flowchart illustrating the printing processing according to the third embodiment. The printing processing according to the third embodiment will be described using FIG. 17. The process of installing the post-processing mechanism and the process of using a sensor to detect whether a post-processing mechanism is installed are similar to that described in the embodiments described above. The following processing will now be described.

In step S171, the CPU 111 receives a print setting from the user. For example, the CPU 111 may display the print setting UI 401 and may receive a print setting instruction from the user. Here, in a case where the user presses the post-processing settings button 406, the CPU 111 may display the post-processing process selection UI 407 and may receive the post-processing process setting from the user. Note that in the present embodiment also, the printing operation table 1110 illustrated in FIG. 11 is stored in the ROM 113.

In step S172, the CPU 111, on the basis of the print setting received from the user, reads out the printing operation program and performs the printing operation so that an image is printed on a printing medium.

In step S173, the CPU 111 determines whether or not a paper jam has occurred during the printing operation. In a case where the CPU 111 determines that a paper jam has not occurred during the printing operation, the CPU 111 ends the printing processing. In a case where the CPU 111 determines that a paper jam has occurred during the printing operation, the CPU 111 proceeds to step S173.

In step S174, the CPU 111 re-sets the print setting received from the user to an alternative print setting. Here, the alternative print setting is a print setting that can suppress the curl amount more than the print setting received from the user, for example. Accordingly, the CPU 111 may reference the printing operation table 1110 illustrated in FIG. 11 and may select an alternative print setting and re-set to it. For example, the CPU 111 may select and re-set, as the alternative print setting, a print setting that is the same as that received from the user except that the anti-curling strength is “2”. Also, on the basis of the occurrence information table 161 illustrated in FIG. 16, the CPU 111 may select and re-set, as the alternative print setting, a print setting for which a paper jam has not occurred. Furthermore, the CPU 111 may display the print setting UI 1305 illustrated in FIG. 13B according to the first embodiment and the print setting UI 1505 illustrated in FIG. 15 according to the second embodiment and may receive an alternative print setting from the user.

In step S175, the CPU 111, on the basis of the re-set alternative print setting, reads out the printing operation program and performs the printing operation again. Note that after the sensor or the user informs the CPU 111 that the paper jam has been resolved, the CPU 111 may resume the printing operation.

As described above, according to the present embodiment, in a case where a paper jam occurs, a print setting for suppressing the curl amount is changed to before the printing operation is restarted. This can reduce repeated occurrences of paper jamming.

### Other Embodiments

The embodiments described above may be combined. In the case of combining the embodiments, the user can select the processing of each embodiment, and the CPU 111 executes the processing on the basis of the user selection.

The present embodiments described above use a serial head, but a linehead may be used. In the case of a linehead, the ink amount applied on the sheet surface at one time is great, and thus a large curl amount can be expected. In this manner, the present embodiment can be even more effective.

In the embodiments described above, the user selects an alternative print setting, and the CPU 111 re-sets the print setting on the basis of this selection. However, the re-setting of the print setting is not limited to this. For example, in a case where the CPU 111 determines that a re-setting condition is satisfied, the CPU 111 may automatically re-set the print setting to a print setting for suppressing curling. In a case where a post-processing process is set and a case where a post-processing mechanism is installed, the CPU 111 may determine that the re-setting condition is satisfied. Note that, as described above, the print setting for suppressing curling may be for further reducing the speed, for further reducing the ink application amount, or for a combination of these.

In the embodiments described above, the CPU 111 of the printing apparatus 108 executes the processing of the print setting and the re-setting of the print setting. However, the active agent of the processing is not limited to the CPU 111. For example, the CPU 102 of the image processing apparatus 101 may execute the processing for the print setting and the re-setting of the print setting. In this case, the CPU 102 displays the user interfaces on the display apparatus of the image processing apparatus 101.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-041585, filed Mar. 15, 2024, which is hereby incorporated by reference herein in its entirety.

What is claimed is:

1. An information processing apparatus that controls an inkjet printing apparatus that prints an image on a printing medium and in which a post-processing mechanism that can execute a plurality of types of post-processing processes on the printing medium printed with the image can be installed at a discharge unit that discharges the printing medium, the information processing apparatus comprising:
a storage unit that stores print settings for printing the image that include at least a first print setting, and a second print setting, which is a print setting for one of the post-processing processes and is different from the first print setting; and
a control unit that sets the print setting, wherein
in a case where the post-processing mechanism is installed, the control unit can set, as a print setting, the second print setting for discharging the printing medium in a state with curling reduced more compared to the first print setting.

2. The information processing apparatus according to claim 1, wherein in a case where the post-processing mechanism is installed, the control unit displays a user interface for a user to select to change to the second print setting and receives a change to the second print setting from the user.

3. The information processing apparatus according to claim 1, wherein the control unit receives shift sorting, stapling, or punching as processing to be executed by the post-processing mechanism.

4. The information processing apparatus according to claim 1, wherein the control unit sets the second print setting to have a lower printing duty cycle than the first print setting.

5. The information processing apparatus according to claim 4, wherein in a case where the printing duty cycle is set low, the control unit displays that a printing density of the image will be reduced.

6. The information processing apparatus according to claim 1, wherein the second print setting is a setting with a longer printing time than the first print setting.

7. The information processing apparatus according to claim 6, wherein in a case where the printing time is set long, the control unit adjusts a waiting time during printing of the image.

8. The information processing apparatus according to claim 6, wherein in a case where the printing time is set long, the control unit adjusts a printing speed of the image.

9. The information processing apparatus according to claim 1, wherein the control unit stores occurrence information indicating whether or not a printing medium jam has occurred, determines a jam on a basis of the occurrence information, and displays a user interface for receiving the second print setting on a basis of the determining.

10. The information processing apparatus according to claim 1, wherein the control unit stores occurrence information indicating whether or not a printing medium jam has occurred and, in a case where a jam occurs during a printing operation, sets the second print setting on a basis of the occurrence information and performs a printing operation again.

11. An inkjet printing apparatus, comprising:
the information processing apparatus according to claim 1; and
a discharge unit that discharges the printing medium with the image printed and is installed with a post-processing mechanism that performs a post-processing process on the printing medium.

12. An information processing method for controlling an inkjet printing apparatus that prints an image on a printing medium and in which a post-processing mechanism that can execute a plurality of types of post-processing processes on the printing medium printed with the image can be installed at a discharge unit that discharges the printing medium, the method comprising:
storing print settings for printing the image that include at least a first print setting, and a second print setting, which is a print setting for one of the post-processing processes and is different from the first print setting; and
setting the print setting, wherein
in setting the print setting, in a case where the post-processing mechanism is installed, as a print setting, the second print setting for discharging the printing medium in a state with curling reduced more compared to the first print setting can be set.

13. A non-transitory computer-readable storage medium storing a computer program for causing, when loaded and executed by a computer that controls an inkjet printing apparatus that prints an image on a printing medium and in which a post-processing mechanism that can execute a plurality of types of post-processing processes on the printing medium printed with the image can be installed at a discharge unit that discharges the printing medium, the computer to:
store print settings for printing the image that include at least a first print setting, and a second print setting, which is a print setting for one of the post-processing processes and is different from the first print setting; and
set the print setting, wherein
in setting the print setting, in a case where the post-processing mechanism is installed, as a print setting, the second print setting for discharging the printing medium in a state with curling reduced more compared to the first print setting can be set.
